(19) United States
(12) Patent Application Publication
(10) Pub. No.: US 2025/0191299 A1
(43) Pub. Date: Jun. 12, 2025

(54) RENDERING METHOD AND APPARATUS FOR 3D MATERIAL, AND DEVICE AND STORAGE MEDIUM

(71) Applicant: Beijing Zitiao Network Technology Co., Ltd., Beijing (CN)

(72) Inventors: Bailin LI, Beijing (CN); Jinyuan CAO, Beijing (CN); Chunji YIN, Beijing (CN); Xinyu LI, Beijing (CN); Guang ZENG, Beijing (CN); Xinting HE, Beijing (CN)

(21) Appl. No.: 18/841,345

(22) PCT Filed: Feb. 21, 2023
(86) PCT No.: PCT/CN2023/077297

§ 371 Date: Aug. 28, 2024

(30) Foreign Application Priority Data
Feb. 25, 2022 (CN) 202210178211.9

(51) Int. Cl. G06T 17/20; G06N 3/045; G06N 3/08

(52) U.S. Cl. CPC G06T 17/20; G06N 3/045; G06N 3/08; G06T 2200/04

(57) ABSTRACT

A rendering method and device for a 3D material, an electronic apparatus, and a storage medium are provided. The method includes: acquiring first original 3D information of a 3D material to be rendered; generating an intermediate rendered graph according to the first original 3D information; and inputting the intermediate rendered graph into a generator of a set generative adversarial neural network, so as to obtain a 3D rendered graph.

The present application claims priority of the Chinese Patent Applications No. 202210178211.9 filed on Feb. 25, 2022, the content of which is incorporated as a part of the present application.

### TECHNICAL FIELD

The present disclosure relates to the technical field of image rendering, and, for example, a rendering method and device for a three-dimension (3D) material, an electronic apparatus and a storage medium.

### BACKGROUND

Conventional rendering methods are divided into real-time rendering and offline rendering. Real-time rendering is generally used in the fields that emphasize interactions such as in games and video props, and offline rendering is generally used in the fields that need high-quality pictures such as movies and computer graphics (CG).

Real-time rendering is limited by performance, so that it is difficult to render complex models and materials, and the rendering effect and accuracy are poor. In contrast, offline rendering can render very realistic and complex effects by ray tracing, but consumes a lot of time.

### SUMMARY

The present disclosure provides a rendering method and device for a 3D material, an electronic apparatus and a storage medium, which can not only improve the accuracy of a rendering effect, but also reduce the calculation amount of rendering, thereby improving the rendering efficiency of the 3D material.

Embodiments of the present disclosure provides a rendering method for a 3D material, including:
acquiring first original 3D information of a 3D material to be rendered;
generating an intermediate rendered graph according to the first original 3D information; and
inputting the intermediate rendered graph into a generator of a set generative adversarial neural network, so as to obtain a 3D rendered graph.

Embodiments of the present disclosure further provide a rendering device for a 3D material, including:
a first original 3D information acquisition module configured to acquire first original 3D information of a 3D material to be rendered;
an intermediate rendered graph generation module configured to generate an intermediate rendered graph according to the first original 3D information; and
a 3D rendered graph acquisition module configured to input the intermediate rendered graph into a generator of a set generative adversarial neural network, so as to obtain a 3D rendered graph.

Embodiments of the present disclosure further provide an electronic apparatus, including:
at least one processing device; and
a storage device configured to store at least one program,
the at least one program, when executed by the at least one processing device, causing the at least one processing device to implement the rendering method for the 3D material according to the embodiments of the present disclosure.

Embodiments of the present disclosure further provide a computer-readable medium, on which a computer program is stored, wherein the computer program, when executed by a processing device, implements the rendering method for the 3D material according to the embodiments of the present disclosure.

### BRIEF DESCRIPTION OF DRAWINGS

FIG. 1 is a flowchart of a rendering method for a 3D material in an embodiment of the present disclosure;

FIG. 2 is a schematic diagram of a grid structure of a generator in an embodiment of the present disclosure;

FIG. 3 is an example diagram of training a set generative adversarial neural network in an embodiment of the present disclosure;

FIG. 4 is a structural schematic diagram of a rendering device for a 3D material in an embodiment of the present disclosure; and

FIG. 5 is a structural schematic diagram of an electronic apparatus in an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” refers to “at least one embodiment”; the term “another embodiment” refers to “at least one other embodiment”; the term “some embodiments” refers to “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifications of “a” and “a plurality” mentioned in the present disclosure are schematic rather than limiting, and those skilled in the art should understand that unless the context clearly indicates otherwise, they should be understood as “one or more”.

The names of messages or information exchanged between multiple devices in the embodiment of the present disclosure are only used for illustrative purposes, and are not used to limit the scope of these messages or information.

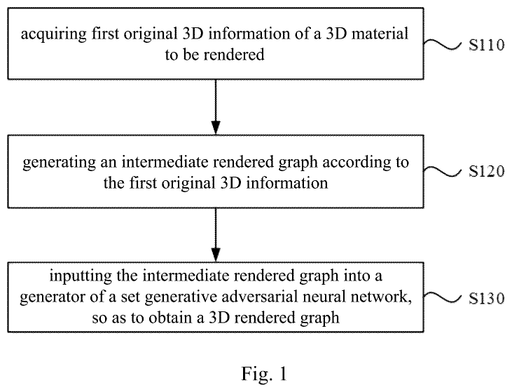

FIG. 1 is a flowchart of a rendering method for a 3D material provided by an embodiment of the present disclosure. The present embodiment can be applied to a case where a 3D rendered graph is generated based on the 3D material. This method can be executed by a rendering device for a 3D material, the device can be composed of hardware and/or software, and can be integrated into an apparatus with a function of rendering the 3D material. The apparatus may be an electronic apparatus such as a server, a mobile terminal or a server cluster, etc. As illustrated by FIG. 1, the method includes the following steps.

S110: acquiring first original 3D information of a 3D material to be rendered.

The 3D material may be any 3D object material to be rendered, for example, 3D characters, 3D animals and 3D plants in a 3D movie or a 3D game. In the present embodiment, when making 3D images, technicians need to build a 3D object material model, so as to acquire the first original 3D information of the 3D material to be rendered.

The first original 3D information may include: vertex coordinates, normal information, camera parameters, surface tiling map and/or illumination parameters.

The vertex coordinates may be three-dimensional coordinates that constitute surface points of the 3D material. The normal information may be a normal vector corresponding to each vertex. Camera parameters include camera internal parameters and camera external parameters, the camera internal parameters include a focal length and other information, and the camera external parameters include camera position information and camera attitude information. The surface tiling map can be understood as a UV map. The illumination parameters may be light source parameters, including: information such as a light source position, light intensity and light colors; or the illumination parameters are represented by vectors with set dimensions.

S120: generating an intermediate rendered graph according to the first original 3D information.

The intermediate rendered graph can be understood as a 3D graph with lower accuracy than a final 3D rendered graph, and can be rasterized for the set generative adversarial neural network to learn to generate a 3D rendered graph with higher accuracy, which may include at least one of a white film map, a normal map, a depth map or a coarse hair map.

Exemplarily, the generating an intermediate rendered graph according to the first original 3D information may be performed by: generating an intermediate rendered graph according to at least one item of the first original 3D information. In the present embodiment, the generation of the intermediate rendered graph may be implemented by using an open source algorithm, which is not limited here. In the present embodiment, the generating the intermediate rendered graph according to at least one item of the first original 3D information can improve the generation efficiency of the intermediate rendered graph.

S130: inputting the intermediate rendered graph into a generator of a set generative adversarial neural network, so as to obtain a 3D rendered graph.

The set generative adversarial neural network may be a stylized trained network, for example, stylization can be the rendering of bubbles, hair, sequins and animals. The set generative adversarial neural network is a pix2pix generative adversarial neural network, which includes a generator and a discriminator.

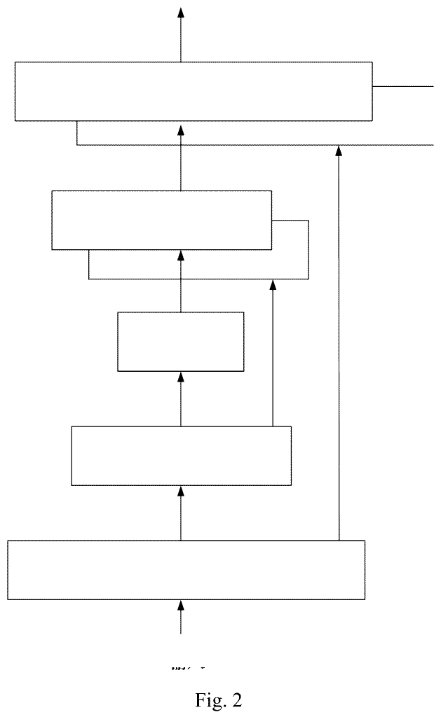

In the present embodiment, network layers in the generator are connected in a U-shaped skipping structure. Exemplarily, FIG. 2 is a schematic diagram of a grid structure of the generator in the present embodiment. As illustrated by FIG. 2, a first layer and a last layer of the network are connected in a skipped manner, a second layer and a last but one layer of the grid are connected in a skipped manner, and so on, thereby forming the U-shaped skipping structure. Using the U-shaped skipping structure for connection can keep the necessary information unchanged and improve the accuracy of network identification.

In the present embodiment, the set adversarial neural network is trained by: acquiring second original 3D information of a 3D material sample to be rendered; generating an intermediate rendered graph sample and a rendered graph sample corresponding to the intermediate rendered graph sample based on the second original 3D information; and performing alternating iterative training on the generator and the discriminator based on the intermediate rendered graph sample and the rendered graph sample corresponding to the intermediate rendered graph sample.

The second original 3D information may include vertex coordinates, normal information, camera parameters, surface tiling map and illumination parameters, etc. The intermediate rendered graph sample may include a white film map, a normal map, a depth map or a coarse hair map, and the intermediate rendered graph sample is obtained by coarse rendering the second original 3D information by a rendering method in the related art. The rendered graph sample is obtained by an offline high-precision rendering algorithm in the related art according to the second original 3D information. The generated rendered graph sample is matched with the intermediate rendered graph sample.

The alternating iterative training on the generator and the discriminator can be understood as that the discriminator is trained one time, the generator is trained one time after the discriminator is trained, the discriminator is trained one time after the generator is trained, and so on, until a training completion condition is met. In the present embodiment, the performing alternating iterative training on the generator and the discriminator based on the intermediate rendered graph sample and the rendered graph sample corresponding to the intermediate rendered graph sample can improve the accuracy of generating the rendered graph by the generator.

In the present embodiment, the performing alternating iterative training on the generator and the discriminator based on the intermediate rendered graph sample and the rendered graph sample corresponding to the intermediate rendered graph sample may be performed by: inputting the intermediate rendered graph sample into a generator, and outputting a generated graph; combining the generated graph and the intermediate rendered graph sample into a negative sample pair, and combining the rendered graph sample and the intermediate rendered graph sample into a positive sample pair; inputting the positive sample pair into the discriminator to obtain a first discrimination result; inputting the negative sample pair into the discriminator to obtain a second discrimination result; determining a first loss function based on the first discrimination result and the second discrimination result; and performing alternating iterative training on the generator and the discriminator based on the first loss function.

The first discrimination result and the second discrimination result may be values between 0 and 1, which are used to characterize a matching degree between sample pairs. For the positive sample pair, its true discriminant result is 0, and for the negative sample pair, its true discriminant result is 1.

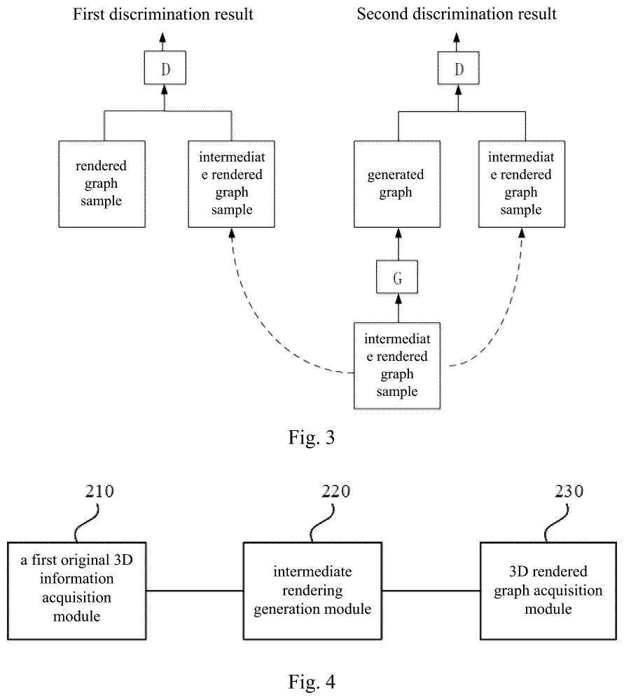

Exemplarily, the determining a first loss function based on the first discrimination result and the second discrimination result may be performed by: calculating a first difference value between the first discrimination result and the true discrimination result corresponding to the positive sample pair, calculating a second difference value between the second discrimination result and the true discrimination result corresponding to the negative sample pair, solving logarithms of the first difference and the second difference respectively and then accumulating to obtain the first loss function. Then, a calculation formula of the first loss function may be expressed as: L1=Σ[log D(x, y)]+Σlog(1−D(x,G(x)), where, x represents an intermediate rendered graph sample, y represents a rendered graph sample, D(x, y) represents a first discrimination result obtained by inputting the intermediate rendered graph sample x and the rendered graph sample y into a discriminator D, G(x) represents a generated graph obtained by inputting the intermediate rendered graph sample x into the generator G, and D(x, G(x)) represents a second discrimination result obtained by inputting the intermediate rendered graph sample x and the generated graph G(x) into the generator G. Exemplarily, FIG. 3 is an example diagram of training a set generative adversarial neural network. As illustrated by FIG. 3, the intermediate rendered graph sample is inputted into the generator G to obtain a generated graph, the generated graph and the intermediate rendered graph sample are inputted into the discriminator D pairwise to obtain a second discrimination result, the intermediate rendered graph sample and the rendered graph sample are inputted into the discriminator D pairwise to obtain a first discrimination result, and alternating iterative training is performed on the generator and the discriminator based on a first loss function determined according to the first discrimination result and the second discrimination result.

Exemplarily, all intermediate rendered graph samples are inputted into the generative adversarial network to obtain a first loss function, and the first loss function performs back propagation to adjust parameters of the discriminator; based on the discriminator with adjusted parameters, all intermediate rendered graph samples are inputted into the generative adversarial network to obtain an updated first loss function, and the updated first loss function performs back propagation to adjust parameters of the generator; then, based on the generator with adjusted parameters, all the intermediate rendered graph samples are inputted into the generative adversarial network to obtain an updated first loss function once more, and the updated first loss function performs back propagation to adjust the parameters of the generator. In this way, alternating iterative training is performed on the generator and the discriminator until a training termination condition is met. In the present embodiment, the performing alternating iterative training on the generator and the discriminator based on the first loss function can improve the accuracy of generating the rendered graph by the generator.

Optionally, after determining the first loss function based on the first discrimination result and the second discrimination result, the method further includes: determining a second loss function according to the generated graph and the rendered graph sample; linearly superposing the first loss function and the second loss function to obtain a target loss function; and performing alternating iterative training on the generator and the discriminator based on the first loss function, including: performing alternating iterative training on the generator and the discriminator based on the target loss function.

The second loss function may be determined by a difference value between the generated graph and the rendered graph sample, and a calculation formula of the second loss function can be expressed as L2=Σ∥y−G(x)∥₁, where y represents the rendered graph sample and G(x) represents the generated graph obtained by inputting the intermediate rendered graph sample x into the generator G. A calculation formula of the target loss function can be expressed as L=L1+λL2, where, λ is a weight coefficient.

Exemplarily, all intermediate rendered graph samples are inputted into the generative adversarial network to obtain a target loss function, and the target loss function performs back propagation to adjust parameters of the discriminator; based on the discriminator with adjusted parameters, all intermediate rendered graph samples are inputted into the generative adversarial network to obtain an updated target loss function, and the updated target loss function performs back propagation to adjust parameters of the generator; then, based on the generator with adjusted parameters, all the intermediate rendered graph samples are inputted into the generative adversarial network to obtain an updated target loss function once more, and the updated target loss function performs back propagation to adjust the parameters of the generator. In this way, alternating iterative training is performed on the generator and the discriminator until a training termination condition is met. In the present embodiment, the performing alternating iterative training on the generator and discriminator based on the target loss function is used to constrain a deviation between the generated graph and the rendered graph, thus improving the accuracy of the generator.

Optionally, the discriminator in the present embodiment adopts a patch discriminator PatchGAN, and the PatchGAN discriminates the inputted sample pairs in patches, outputs a sub-discrimination result of each patch, and averages the multiple sub-discrimination results to obtain a final discrimination result of the sample pairs. By using the patch discriminator, the accuracy of the discriminator can be improved.

Exemplarily, by inputting the intermediate rendered graph into the generator of the trained set generative adversarial neural network, a 3D rendered graph with a corresponding style can be outputted.

In a technical solution of the embodiment of the present disclosure, first original 3D information of a 3D material to be rendered is acquired; an intermediate rendered graph is generated according to the first original 3D information; and the intermediate rendered graph is inputted into a generator of a set generative adversarial neural network, so as to obtain a 3D rendered graph. In the rendering method for the 3D material provided by the embodiment of the present disclosure, the intermediate rendered graph generated by the first original 3D information is inputted the set generative adversarial neural network to obtain the rendered graph, which can not only improve the accuracy of a rendering effect, but also reduce the calculation amount of rendering, thereby improving the rendering efficiency of the 3D material.

FIG. 4 is a structural schematic diagram of a rendering device for a 3D material provided by an embodiment of the present disclosure. As illustrated by FIG. 4, the device includes the following modules:
a first original 3D information acquisition module 210 configured to acquire first original 3D information of a 3D material to be rendered;
an intermediate rendering generation module 220 configured to generate an intermediate rendered graph according to the first original 3D information; and
a 3D rendered graph acquisition module 230 configured to input the intermediate rendered graph into a generator of a set generative adversarial neural network, so as to obtain a 3D rendered graph.

Optionally, the first original 3D information includes: vertex coordinates, normal information, camera parameters, surface tiling map and/or illumination parameters.

Optionally, the intermediate rendered graph generation module 220 is configured to:
generate the intermediate rendered graph according to at least one item of the first original 3D information, where the intermediate rendered graph includes at least one of a white film map, a normal map, a depth map, a coarse hair map.

Optionally, the set generative adversarial neural network is a pix2pix generative adversarial neural network, which includes a generator and a discriminator; the device further includes: a set adversarial neural network training module configured to:
acquire second original 3D information of a 3D material sample to be rendered;
generate an intermediate rendered graph sample and a rendered graph sample corresponding to the intermediate rendered graph sample based on the second original 3D information; and
perform alternating iterative training on the generator and the discriminator based on the intermediate rendered graph sample and the rendered graph sample corresponding to the intermediate rendered graph sample.

The set adversarial neural network training module is further configured to:
input the intermediate rendered graph sample into the generator and output a generated graph;
combine the generated graph and the intermediate rendered graph sample into a negative sample pair, and combine the rendered graph sample and the intermediate rendered graph sample into a positive sample pair;
input the positive sample pair into the discriminator to obtain a first discrimination result, and input the negative sample pair into the discriminator to obtain a second discrimination result;
determine a first loss function based on the first discrimination result and the second discrimination result; and
perform alternating iterative training on the generator and the discriminator based on the first loss function.

The set adversarial neural network training module is further configured to: determine a first loss function based on the first discrimination result and the second discrimination result,
then determine a second loss function according to the generated graph and the rendered graph sample;
linearly superpose the first loss function and the second loss function to obtain a target loss function; and
perform alternating iterative training on the generator and the discriminator based on the first loss function, including
performing alternating iterative training on the generator and the discriminator based on the target loss function.

Optionally, network layers in the generator are connected in a U-shaped skipping structure; and the discriminator adopts a patch discriminator PatchGAN.

The device can execute the methods provided by all the aforementioned embodiments of the present disclosure, and has corresponding functional modules and beneficial effects. For technical details that are not described in detail in the present embodiment, please refer to the methods provided by all the previous embodiments of the present disclosure.

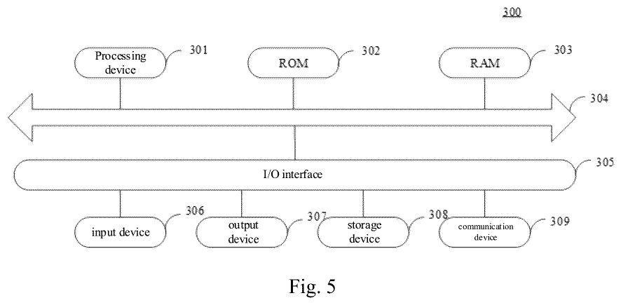

Hereinafter, referring to FIG. 5, which shows a structural schematic diagram of an electronic apparatus 300 suitable for implementing an embodiment of the present disclosure. The electronic apparatus in the embodiment of the present disclosure may include, but are not limited to, mobile terminals such as mobile phones, notebook computers, digital broadcast receivers, PDA (Personal Digital Assistant), PAD (Tablet Computer), PMP (Portable Multimedia Player), vehicle-mounted terminals (such as vehicle-mounted navigation terminals), and fixed terminals such as digital TV, desktop computers, or various forms of servers, such as independent servers or server clusters. The electronic apparatus shown in FIG. 5 is only an example, and should not bring any limitation to the function and application scope of the embodiment of the present disclosure.

As illustrated by FIG. 5, the electronic apparatus 300 may include a processing device (such as a central processing unit, a graphics processor, etc.) 301, which may perform various appropriate actions and processes according to a program stored in a read-only storage device (ROM) 302 or a program loaded from a storage device 305 into a random access storage device (RAM) 303. In the RAM 303, various programs and data required for the operation of the electronic apparatus 300 are also stored. The processing device 301, the ROM 302 and the RAM 303 are connected to each other through a bus 304. An input/output (I/O) interface 305 is also connected to the bus 304.

Generally, the following devices can be connected to the I/O interface 305: an input device 306 including, for example, a touch screen, a touch pad, a keyboard, a mouse, a camera, a microphone, an accelerometer, a gyroscope, etc.; an output device 307 including, for example, a liquid crystal display (LCD), a speaker, a vibrator, etc.; a storage device 308 such as a magnetic tape, a hard disk, etc.; and a communication device 309. The communication device 309 may allow the electronic apparatus 300 to perform wireless or wired communication with other devices to exchange data. Although FIG. 5 shows an electronic apparatus 300 with various devices, it should be understood that it is not required to implement or have all the devices shown. More or fewer devices may alternatively be implemented or provided.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program code for executing a word recommendation method. In such an embodiment, the computer program can be downloaded and installed from the network through the communication device 309, or installed from the storage device 305, or installed from the ROM 302. When the computer program is executed by the processing device 301, the above functions defined in the method of the embodiment of the present disclosure are performed.

It should be noted that the computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, device or apparatus, or a combination of any of the above. More specific examples of computer-readable storage media may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, device or apparatus. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, device or apparatus. The program code contained in the computer-readable medium can be transmitted by any suitable medium, including but not limited to: wires, optical cables, RF (radio frequency) and the like, or any suitable combination of the above.

In some embodiments, the client and the server can communicate by using any currently known or future developed network protocol such as HTTP (Hyper Text Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc end-to-end networks), as well as any currently known or future developed networks.

The computer-readable medium may be included in the electronic apparatus; or it can exist alone without being assembled into the electronic equipment.

The computer-readable medium carries one or more programs, which, when executed by the electronic apparatus, cause the electronic apparatus to: acquire the first original 3D information of the 3D material to be rendered; Generating an intermediate rendering according to the first original 3D information; Inputting the intermediate rendering into a generator set to generate a countermeasure neural network to obtain a 3D rendering.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiment described in the present disclosure can be realized by software or hardware. Among them, the name of the unit does not constitute the limitation of the unit itself in some cases.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, device or apparatus. The machine-readable medium may be a machine-readable signal medium or a machine-readable storage medium. A machine-readable medium may include, but is not limited to, an electronic, magnetic, optical, electromagnetic, infrared, or semiconductor system, device or equipment, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any suitable combination of the above. The storage medium can be a non-transitory storage medium.

According to one or more embodiments of the present disclosure, the embodiments of the present disclosure provide a rendering method for a 3D material, including:
acquiring first original 3D information of a 3D material to be rendered;
generating an intermediate rendered graph according to the first original 3D information; and
inputting the intermediate rendered graph into a generator of a set generative adversarial neural network, so as to obtain a 3D rendered graph.

In one or more embodiments, the first original 3D information comprises at least one selected from the group consisting of vertex coordinates, normal information, camera parameters, surface tiling map and illumination parameters.

In one or more embodiments, the generating an intermediate rendered graph according to the first original 3D information comprises:
generating the intermediate rendered graph according to at least one item of the first original 3D information, wherein the intermediate rendered graph comprises at least one selected from the group consisting of a white film map, a normal map, a depth map, and a coarse hair map.

In one or more embodiments, the set generative adversarial neural network is a pix2pix generative adversarial neural network comprising a generator and a discriminator; and the set adversarial neural network is trained by:
acquiring second original 3D information of a 3D material sample to be rendered;
generating an intermediate rendered graph sample and a rendered graph sample corresponding to the intermediate rendered graph sample based on the second original 3D information; and
performing alternating iterative training on the generator and the discriminator based on the intermediate rendered graph sample and the rendered graph sample corresponding to the intermediate rendered graph sample.

In one or more embodiments, the performing alternating iterative training on the generator and the discriminator based on the intermediate rendered graph sample and the rendered graph sample corresponding to the intermediate rendered graph sample comprises:
inputting the intermediate rendered graph sample into the generator and outputting a generated graph;
combining the generated graph and the intermediate rendered graph sample into a negative sample pair, and combining the rendered graph sample and the intermediate rendered graph sample into a positive sample pair;
inputting the positive sample pair into the discriminator to obtain a first discrimination result, and inputting the negative sample pair into the discriminator to obtain a second discrimination result;
determining a first loss function based on the first discrimination result and the second discrimination result; and
performing alternating iterative training on the generator and the discriminator based on the first loss function.

In one or more embodiments, after the determining a first loss function based on the first discrimination result and the second discrimination result, the method further comprises:
determining a second loss function according to the generated graph and the rendered graph sample; and
linearly superposing the first loss function and the second loss function to obtain a target loss function; and
the performing alternating iterative training on the generator and the discriminator based on the first loss function comprises:
performing alternating iterative training on the generator and the discriminator based on the target loss function.

In one or more embodiments, network layers in the generator are connected in a U-shaped skipping structure; and the discriminator adopts a patch discriminator PatchGAN.

1. A rendering method for a 3D material, comprising:
acquiring first original 3D information of a 3D material to be rendered;
generating an intermediate rendered graph according to the first original 3D information; and
inputting the intermediate rendered graph into a generator of a set generative adversarial neural network, so as to obtain a 3D rendered graph.

2. The method according to claim 1, wherein the first original 3D information comprises at least one selected from the group consisting of vertex coordinates, normal information, camera parameters, surface tiling map and illumination parameters.

3. The method according to claim 2, wherein the generating an intermediate rendered graph according to the first original 3D information comprises:
generating the intermediate rendered graph according to at least one item of the first original 3D information, wherein the intermediate rendered graph comprises at least one selected from the group consisting of a white film map, a normal map, a depth map, and a coarse hair map.

4. The method according to claim 1, wherein the set generative adversarial neural network is a pix2pix generative adversarial neural network comprising a generator and a discriminator; and the set adversarial neural network is trained by:
acquiring second original 3D information of a 3D material sample to be rendered;
generating an intermediate rendered graph sample and a rendered graph sample corresponding to the intermediate rendered graph sample based on the second original 3D information; and
performing alternating iterative training on the generator and the discriminator based on the intermediate rendered graph sample and the rendered graph sample corresponding to the intermediate rendered graph sample.

5. The method according to claim 4, wherein the performing alternating iterative training on the generator and the discriminator based on the intermediate rendered graph sample and the rendered graph sample corresponding to the intermediate rendered graph sample comprises:
inputting the intermediate rendered graph sample into the generator and outputting a generated graph;
combining the generated graph and the intermediate rendered graph sample into a negative sample pair, and combining the rendered graph sample and the intermediate rendered graph sample into a positive sample pair;
inputting the positive sample pair into the discriminator to obtain a first discrimination result, and inputting the negative sample pair into the discriminator to obtain a second discrimination result;
determining a first loss function based on the first discrimination result and the second discrimination result; and
performing alternating iterative training on the generator and the discriminator based on the first loss function.

6. The method according to claim 5, wherein after the determining a first loss function based on the first discrimination result and the second discrimination result, the method further comprises:
determining a second loss function according to the generated graph and the rendered graph sample; and
linearly superposing the first loss function and the second loss function to obtain a target loss function; and
the performing alternating iterative training on the generator and the discriminator based on the first loss function comprises:
performing alternating iterative training on the generator and the discriminator based on the target loss function.

7. The method according to claim 4, wherein network layers in the generator are connected in a U-shaped skipping structure; and the discriminator adopts a patch discriminator PatchGAN.

8. (canceled)

9. (canceled)

10. (canceled)

11. The method according to claim 5, wherein values of the first discrimination result and the second discrimination result range from 0 to 1, and are configured to characterize a matching degree between sample pairs.

12. The method according to claim 5, wherein the determining a first loss function based on the first discrimination result and the second discrimination result comprises:
calculating a first difference value between the first discrimination result and a true discrimination result corresponding to the positive sample pair, calculating a second difference value between the second discrimination result and a true discrimination result corresponding to the negative sample pair, solving logarithms of the first difference and the second difference respectively and then accumulating to obtain the first loss function.

13. A rendering device for a 3D material, comprising:
a first original 3D information acquisition module configured to acquire first original 3D information of a 3D material to be rendered;
an intermediate rendered graph generation module configured to generate an intermediate rendered graph according to the first original 3D information; and
a 3D rendered graph acquisition module configured to input the intermediate rendered graph into a generator of a set generative adversarial neural network, so as to obtain a 3D rendered graph.

14. An electronic apparatus, comprising:
at least one processing apparatus; and
a storage apparatus configured to store at least one program,
the at least one program, when executed by the at least one processing apparatus, causing the at least one processing apparatus to acquire first original 3D information of a 3D material to be rendered; generate an intermediate rendered graph according to the first original 3D information; and input the intermediate rendered graph into a generator of a set generative adversarial neural network, so as to obtain a 3D rendered graph.

15. The electronic apparatus according to claim 14, wherein the first original 3D information comprises at least one selected from the group consisting of vertex coordinates, normal information, camera parameters, surface tiling map and illumination parameters.

16. The electronic apparatus according to claim 15, wherein the generating an intermediate rendered graph according to the first original 3D information comprises:
generating the intermediate rendered graph according to at least one item of the first original 3D information, wherein the intermediate rendered graph comprises at least one selected from the group consisting of a white film map, a normal map, a depth map, and a coarse hair map.

17. The electronic apparatus according to claim 14, wherein the set generative adversarial neural network is a pix2pix generative adversarial neural network comprising a generator and a discriminator; and the set adversarial neural network is trained by:
acquiring second original 3D information of a 3D material sample to be rendered;
generating an intermediate rendered graph sample and a rendered graph sample corresponding to the intermediate rendered graph sample based on the second original 3D information; and
performing alternating iterative training on the generator and the discriminator based on the intermediate rendered graph sample and the rendered graph sample corresponding to the intermediate rendered graph sample.

18. The electronic apparatus according to claim 17, wherein the performing alternating iterative training on the generator and the discriminator based on the intermediate rendered graph sample and the rendered graph sample corresponding to the intermediate rendered graph sample comprises:
inputting the intermediate rendered graph sample into the generator and outputting a generated graph;
combining the generated graph and the intermediate rendered graph sample into a negative sample pair, and combining the rendered graph sample and the intermediate rendered graph sample into a positive sample pair;
inputting the positive sample pair into the discriminator to obtain a first discrimination result, and inputting the negative sample pair into the discriminator to obtain a second discrimination result;
determining a first loss function based on the first discrimination result and the second discrimination result; and
performing alternating iterative training on the generator and the discriminator based on the first loss function.

19. The electronic apparatus according to claim 18, wherein values of the first discrimination result and the second discrimination result range from 0 to 1, and are configured to characterize a matching degree between sample pairs.

20. The electronic apparatus according to claim 18, wherein the determining a first loss function based on the first discrimination result and the second discrimination result comprises:
calculating a first difference value between the first discrimination result and a true discrimination result corresponding to the positive sample pair, calculating a second difference value between the second discrimination result and a true discrimination result corresponding to the negative sample pair, solving logarithms of the first difference and the second difference respectively and then accumulating to obtain the first loss function.

21. The electronic apparatus according to claim 18, wherein after the determining a first loss function based on the first discrimination result and the second discrimination result, the method further comprises:
determining a second loss function according to the generated graph and the rendered graph sample; and
linearly superposing the first loss function and the second loss function to obtain a target loss function; and
the performing alternating iterative training on the generator and the discriminator based on the first loss function comprises:
performing alternating iterative training on the generator and the discriminator based on the target loss function.

22. The electronic apparatus according to claim 18, wherein network layers in the generator are connected in a U-shaped skipping structure; and the discriminator adopts a patch discriminator PatchGAN.

23. A computer-readable medium, on which a computer program is stored, wherein the computer program, when executed by a processing apparatus, implements the rendering method for the 3D material according to claim 1.
